(19) United States
(12) Patent Application Publication
(10) Pub. No.: US 2010/0275891 A1
(43) Pub. Date: Nov. 4, 2010

(54) INTERNAL COMBUSTION ENGINE

(76) Inventor: Friedrich GRUBER, Hippach (AT)

Correspondence Address: WENDEROTH, LIND & PONACK, L.L.P., 1030 15th Street, N.W.,, Suite 400 East, Washington, DC, 20005-1503, US

(21) Appl. No.: 12/839,538

(22) Filed: Jul. 20, 2010

Related U.S. Application Data
(63) Continuation of application No. PCT/AT2009/000042, filed on Feb. 4, 2009.

(30) Foreign Application Priority Data
Feb. 18, 2008 (AT) A 256/2008

(51) Int. Cl. F02B 33/00

(52) U.S. Cl. 123/564

(57) ABSTRACT

A method for operating an internal combustion engine, comprising a compression device, an air/fuel mixture being compressed in the compression device, the air/fuel mixture ratio λ₂ of the air/fuel mixture fed to a cylinder of the internal combustion engine being varied as a function of the load of the internal combustion engine, the air/fuel mixture ratio λ₁ of air/fuel mixture compressed in the internal combustion engine being higher than the air/fuel ratio λ₂ of the air/fuel mixture fed to the cylinder, characterized in that the air/fuel ratio λ₁ of air/fuel mixture compressed in the compression device is selected such that it is not ignitable under the conditions in the compression device and/or upstream of the compression device.

The invention relates to a method for operating an internal combustion engine having a compression device, wherein an air/fuel mixture is compressed in the compression device, wherein the air/fuel ratio λ₂ of the air/fuel mixture fed to a cylinder of the internal combustion engine is varied as a function of the load of the internal combustion engine. The invention further relates to an internal combustion engine and to a regulating device.

In supercharged internal combustion engines, i.e. internal combustion engines, in particular gas engines, in which an air/fuel mixture is compressed before it is admitted into the combustion chamber of a cylinder, the danger arises that back-firing, for example, from the combustion chamber can ignite the air/fuel mixture in the mixing lines up to the common feed for fuel and air upstream of the compressor. This means that large blast waves may be produced, especially as a result of a high boost pressure when the internal combustion engine is under full load. In large gas engines with large volume mixture feed lines in particular, this gives rise to a considerable potential for damage and to major safety problems.

For this reason, large gas engines with powers of more than about 3 MW are usually not operated with supercharging but with port injection. The term “port injection” is understood to mean a fuel admission device in the intake line directly upstream of the cylinder heads or the intake valves of the engine. All of the fuel can be fed to the individual cylinders as required via these fuel intake devices.

One of the disadvantages of port injection as opposed to supercharging is the difficulty of ensuring as homogeneous a mixture as possible in the combustion chamber of the internal combustion engine. A further serious disadvantage is that, in particular with fuels with a low calorific value, large volumes have to be injected at high pressures. This requires large fuel intake valves and high compressive power in order to produce the required fuel pressure.

Thus, a first aim of the present invention is to provide a method which can overcome the disadvantages of the prior art. In particular, back-firing from the combustion chamber to the fuel intake zone, the compression device and, if appropriate, the air/fuel mixing device, should be prevented. In addition, it should provide an internal combustion engine and a regulating device for operating an internal combustion engine which overcomes this problem.

This aim is achieved by the independent claims.

Thus, in a method for operating an internal combustion engine having a compression device, wherein an air/fuel mixture is compressed in the compression device, and wherein the air/fuel ratio λ₁ of the air/fuel mixture fed to a cylinder of the internal combustion engine is varied as a function of the load of the internal combustion engine, the air/fuel mixture supplied to the cylinder has a lower air/fuel ratio λ₂ than the air/fuel mixture which is compressed in the compression device.

Because the air/fuel mixture, in the upstream direction of the intake section, has such a high air/fuel ratio λ₁ that it is not ignitable under the conditions prevailing in the compression device and/or upstream of the compression device and enrichment of the mixture only occurs after the compression device, back-firing in the intake section can be almost completely excluded. The prior art document, DE 103 39 854 A1, describes enrichment of the mixture downstream of the compression device, but that only solves problems linked to supercharger pressure drops upon changes in load. In this regard, DE 103 39 854 A1 clearly describes that only a small quantity of gas is contained in an already well-homogenized gas-air mixture. As a consequence, enrichment of the mixture in DE 103 39 854 A1 is minimal and thus neither the inventive concept nor its technical teaching is disclosed.

In this regard, particularly preferably, the air/fuel ratio λ₂ of the air/fuel mixture supplied to the cylinder is reduced such that the compressed air/fuel mixture is supplied with fuel and/or a fuel/air mixture with a lower λ₃ downstream of the compression device. In the preferred case, this may be carried out, for example, by supplying either pure fuel or a fuel/air mixture directly to an intake valve with a lower λ₃ in the intake section to thereby enrich the fuel/air mixture for combustion in the combustion chamber. Alternatively, the fuel or fuel/air mixture supplied downstream of the compression device with a lower λ₃ is admitted directly into the cylinder or into the combustion chamber of the cylinder.

As an example, the method may combine known supercharging with port injection.

In the preferred case, at least approximately ⅔ of the fuel is compressed with the combustion air via the compression device (supercharging), while the remaining fuel is supplied immediately upstream of or in the vicinity of the intake valve of the cylinder, for example via a port injection device.

In a preferred implementational variation, the air/fuel ratio λ₁ of the air/fuel mixture which is compressed in the compression device is selected so that it is not ignitable under the conditions in the compression device and/or upstream of the compression device. The exact value of λ₁ for the air/fuel mixture is a function of the selected fuel and the prevailing pressure and temperature conditions. In lean burn (large) gas engines (λ approximately 1.7), constituting the preferred arena of application of the invention, for conditions which are normal when using CH₄ as the fuel, values for λ in the region of ≧2 may be set in order to minimize the risk of back-firing to practically 0. With other fuels, such as biogas, for example the value for λ may be substantially lower (for example approximately 1.8), while with H₂, values for λ of more than 2.1 would be advantageous. However, the value for λ₁ should be set high enough that the advantages of supercharging are not forfeited. In practice, therefore, the value for λ₁ will be set just above the critical value, as a function of the appropriate fuel.

An internal combustion engine in accordance with the invention comprises at least the following: an air intake, a first fuel intake, a fuel/air mixing device, wherein the air intake and first fuel intake discharge into the fuel/air mixing device, a compression device connected downstream of the fuel/air mixing device, a second fuel intake which is connected downstream of the compression device, an intake manifold, a cylinder in which a combustion chamber is formed, as well as a regulating device or a control device, wherein the regulating device or control device regulates or controls the supply of fuel to the combustion chamber as a function of the operating state of the internal combustion engine via the at least two fuel intakes, wherein the regulating device or control device adjusts the air/fuel ratio λ₁ of the air/fuel mixture which is compressed in the compression device so that it is not ignitable under the conditions in the compression device and/or upstream of the compression device.

Thus, in the preferred case, it may further be provided that the regulating device keeps the air/fuel ratio λ₁ supplied via the first fuel intake essentially constant and adjusts the fuel supply as a function of the operating state of the internal combustion engine, for example via actuators, via the second fuel intake. Valves may constitute appropriate actuators for regulating the quantity of fuel. The direction of flow herein is the direction of gas flow of the fuel/air mixture from the fuel/air mixing device to the combustion chambers of the internal combustion engine. The term “upstream” of the compression device herein therefore means the region opposite to the direction of gas flow right up to the fuel/air mixing device.

The advantageous features of the method mentioned above can clearly be transferred in terms of structure to the advantageous embodiments of the internal combustion engine described in more detail below; thus, for the sake of clarity, we shall not describe every advantageous embodiment afresh.

Advantageously, the second fuel intake discharges into the intake manifold, or the second fuel intake is formed as a port injector, or the second fuel intake discharges directly into the combustion chamber of the cylinder.

In addition to the method described above and the internal combustion engine described above, obviously a regulating device is also provided for such a method or internal combustion engine according to this invention.

Further advantages and details will become apparent from the Figures and the accompanying description thereof.

The Figures show:

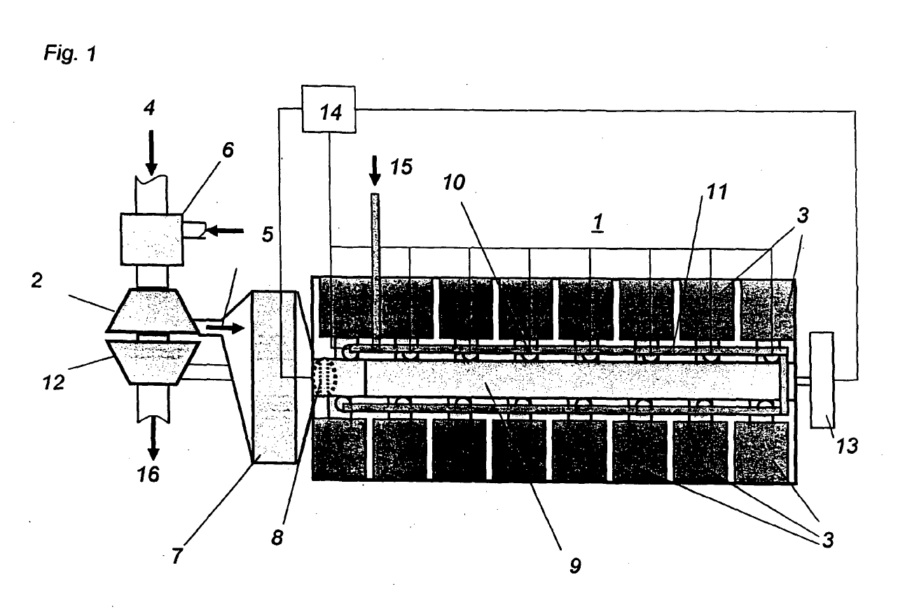

FIG. 1 a general representation of an internal combustion engine with a regulating device for carrying out the method of the invention;

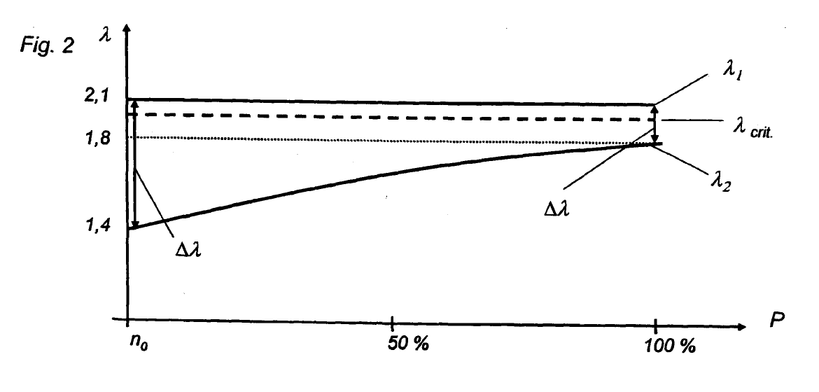

FIG. 2 a diagram of the air/fuel ratio 2 as a function of the engine load P as an implementational example of carrying out the method of the invention; and

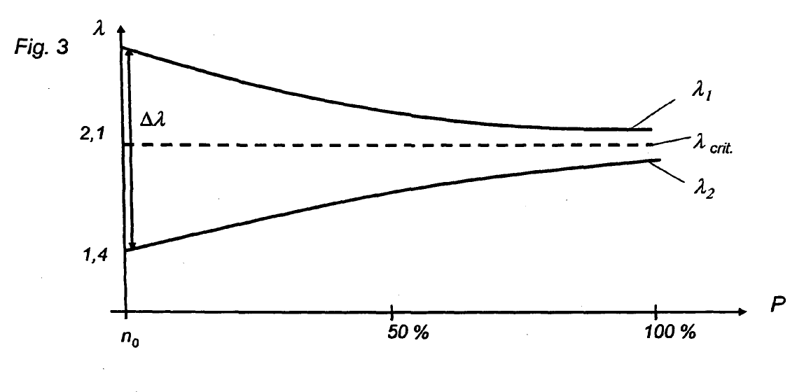

FIG. 3 a diagram similar to FIG. 2 showing an alternative implementational example of carrying out the method of the invention.

FIG. 1 shows a general representation of an internal combustion engine 1 comprising an air intake 4, a first fuel intake 5 and a fuel/air mixing device 6. The air intake 4 and first fuel intake 5 discharge into the fuel/air mixing device 6. It is followed downstream by a compression device 2 which is driven by an exhaust turbine 12. The exhaust turbine 12 is driven by exhaust gases 16 from the combustion of air/fuel mixtures in the cylinders 3 of the internal combustion engine 1. The internal combustion engine 1 shown has sixteen cylinders 3 which are fed with air/fuel mixture from the fuel/air mixing device 6 via an intake manifold 9. Before the air/fuel mixture flows into the intake manifold 9, the air/fuel mixture compressed in the compression device 2 is cooled to the desired temperature in a mixture cooler 7. The actual quantity of air/fuel mixture is regulated via a throttle device 8. A second fuel intake 15 connected downstream of the compression device 2 discharges via a manifold 11 into the individual cylinders 3. In the embodiment shown, pure fuel is supplied via the second fuel intake 15 and is admitted via actuators 10 in the form of valves or so-called port injectors into the zone of the intake valves. Alternatively, the fuel may be admitted into the cylinder 3 directly from the second fuel intake 15. A regulating device 14 now controls the process by regulating the quantity of air/fuel mixture with a low value λ₁ leaving the compression device 2 as a function of the engine load P on a motor shaft 13 via the throttle device 8 and supplying additional fuel as a function of load P via the actuators 10. Two implementational examples of the method of the invention are described in more detail in FIGS. 2 and 3.

In a further alternative, instead of pure fuel, an air/fuel mixture may be supplied via the second fuel feed 15 which has a value λ* which is lower than the value λ₁ for the compressed air/fuel mixture. In this case, it would be possible to provide a further fuel/air mixing device in the region of the second fuel feed 15. In this case too, the air/fuel mixture can be admitted with a value λ* which is lower than the value λ₁ for the compressed air/fuel mixture, for example directly into the cylinder 3 or into the region of the intake valves (i.e. just before the cylinders 3).

Since the described preferred embodiment discloses a gas engine, the fuel in this case is a gaseous fuel such as methane, for example, which does not have to have been pre-treated, for example, in a carburetor. The second fuel which is supplied via the second fuel feed 15 can in this case be a different fuel from that fuel which is supplied via the first fuel feed 5. As an example, another fuel gas (for example H₂ as the second fuel, CH₄ as the first fuel) or a liquid fuel may be used. Depending on the fuel, the second fuel may be supplied in the liquid form, such as pressure-liquefied hydrogen, liquefied CH₄ or higher hydrocarbon compounds. If appropriate, then, a carburetor is provided for the fuel.

Preferred implementations will be described with reference to FIGS. 2 and 3. In a manner similar to supercharged gas engines, the major fraction of the fuel is metered or mixed into the combustion air upstream of the compression device 2 of an exhaust gas turbine 12. This air/fuel mixture has a first value λ₁. In the internal combustion engine 1, an air/fuel mixture with a second value λ₂ is burned. λ₂ is varied as a function of the engine load P. At idling speed, n₀, the value λ₂ is lower than at full load, P=100%, of the engine. λ_{crit} represents the upper limit for back-firing in the lines supplying the mixture upstream to the intake valves. The difference Δλ from λ₁ to λ₂ thus falls with increasing load P. In contrast to pure supercharging, the mixing ratio of fuel to air is thus kept so lean that under the conditions in the mixing lines (i.e. every zone upstream of the cylinder or the zone upstream of the intake valves), the air/fuel mixture is not ignitable. When using fuels with extremely broad limits of inflammability, the mixing ratio can be selected so that the laminar burn rate is very small and thus blast waves can no longer be formed. As an example, highly supercharged natural gas lean burn engines can be operated at full load with a λ₂ value of approximately 1.7-1.9. The lean limit of inflammability λ_{crit} of air/natural gas mixtures under the conditions prevailing in the mixing lines is approximately λ_{crit}=2.1. In this case, approximately 80% of the fuel can be compressed with the combustion air and only approximately 20% of the fuel would be supplied via the port injection valves 10 upstream of the intake valves. With fuels with a large fraction of hydrogen (>50%), the minimum λ_{crit}, at which the risk of back-firing becomes uncritical, is approximately 3. In this case, the fuel quantities are divided as follows: upstream of the compression device, approximately 77%; via port injection valves 10, approximately 23%. Regulation or control or distribution of the fuel into the two feeds 5, 15 can thus be carried out such that for the gas intake 4 upstream of the compression device 2 (premixing), for example via known gas mixing devices 6, a predetermined fixed mixing ratio is set which corresponds to the smallest allowed λ₁>λ_{crit} value for which there is still no back-firing risk for the whole performance range P. As an example, a mixing ratio λ₁ may be established which is constant over the whole performance range P. Normally, gas mixers are used which have set mixing cross sections.

FIG. 2 shows an example of the λ₁ curve for pre-mixing with natural gas as a fuel which is constant over the performance range P of the internal combustion engine. The λ₂ burned in the combustion chamber of the internal combustion engine increases continuously with increasing power. In the simplest case, this constitutes a combined solution of supercharging and port injection. When the engine is idling (n₀), the port injection device admits approximately 3% and at 100% load P approximately 15% of the full load gas quantity, and thus adjusts the value λ₂ for combustion to the desired value.

FIG. 3 shows an alternative curve for the “premix lambda” λ₁ wherein the mixture is leaner under partial load than under full load: λ₁ (partial load)>λ₁ (full load). This method is advantageously then used when, in particular with high calorific values for gases, the quantity of gas when idling or under low partial load becomes too low for the port injection valves and thus the sensitivity and accuracy of the metering devices become problematic.

Designs which envisage that the “premix lambda” λ₁ will become leaner from idling, n₀, to full load, P=100%, are basically possible but are less advantageous for the reasons given above.

Varied limiting conditions, for example variations in the fuel gas composition can, as is usual with supercharged gas engines, be compensated for by intervening in the control of the adjustment device for the gas feed cross sections in the gas mixer so that a correct mode of operation is ensured at all times.

In contrast to the quantity of fuel mixture which is supplied via the port injection device of the internal combustion engine, no great demands are placed on the dynamics of the fuel supply upstream of the compression device 2. Rapid variations in the mixing ratio of fuel and air upstream of the compression device 2 are not necessary with the combined use of supercharging and port injection. This makes engine management easier and has a stabilizing influence on the λ regulating system.

The quantity of port injection gas is controlled and regulated in a highly dynamic manner when the actual or transient engine operation calls for it. The threshold parameters derive, for example, from the λ regulating device for the engine taking into account further boundary conditions and criteria, for example when rapid, problem-specific reactions are required when releasing load or applying load. Furthermore, the quantity of gas can be individually matched or adjusted for each cylinder using the port injection system.

In the embodiment shown, the two fuel supply devices are decoupled and do not have an influence on each other. As an example, dynamic processes (for example fast variations in the quantity of fuel supplied by port injection) have no influence on the premix λ₁.

It is also entirely possible to envisage an alternative operation providing, for example, a switch-over from pure port injection to pure supercharging or vice versa. It is also possible to conceptualize a method changing from combined supercharging/port injection to port injection alone or to supercharging alone or vice versa. Such concepts may be appropriate with the alternative use of different fuel gases with very different properties (for example when switching or adding fuel gas when mixing in alternative fuel gases). The advantages of the proposed solutions over the respective standard methods will now be summarized in brief:

Advantages over pure port injection:
better homogenization of the mixture;
low sensitivity to inaccuracies in the port injection device, greater tolerance to errors;
smaller injection valves required;
lower gas compressor capacities required (in particular for fuel gases with low calorific values or fuel gases which are not available at a high enough pressure);
smaller differences in gas injection quantities between idling and full load, and thus greater accuracy of the port injection system when idling and in the low load range.

Advantages over pure supercharging:
reduction in back-firing risk and reduction in potential danger upon back-firing (lower mixture energy, mixture outside limits of flammability or very low burn rate)—faster behaviour in response by avoiding dead zones (of particular importance for isolated operation applications);
possibility of switching cylinder off and on without the fear of back-firing and detonation;
possibility of regulating the mixture cylinder by cylinder (for example balancing the cylinders).

Only a small additional cost over the pure method stands in the way of the advantages. In this regard, the cost of a port injection concept is substantially higher than for supercharging. Pure supercharging is no longer viable on safety grounds, particularly with large engines. Such engines usually incorporate port injection concepts. The additional cost for a combination method (port injection+supercharging) in such cases is relatively low, but the advantages as shown above are substantial.

1. A method for operating an internal combustion engine comprising a compression device, wherein an air/fuel mixture is compressed in the compression device, wherein the air/fuel ratio λ₂ of the air/fuel mixture fed to a cylinder of the internal combustion engine is varied as a function of the load of the internal combustion engine, wherein the air/fuel ratio λ₁ of the air/fuel mixture compressed in the internal combustion engine is higher than the air/fuel ratio λ₂ of the air/fuel mixture fed to the cylinder, characterized in that the air/fuel ratio λ₁ of the air/fuel mixture which is compressed in the compression device is selected such that it is not ignitable under the conditions in the compression device and/or upstream of the compression device.

2. A method according to claim 1, wherein the air/fuel ratio λ₂ of the air/fuel mixture which is supplied to the cylinder is reduced, wherein downstream of the compression device, fuel or a fuel/air mixture with a lower air/fuel ratio λ* is supplied to the compressed air/fuel mixture.

3. A method according to claim 2, wherein the fuel or fuel/air mixture supplied downstream of the compression device is admitted directly into the cylinder with a lower air/fuel ratio λ*.

4. A method according to claim 2, wherein the fuel or fuel/air mixture supplied downstream of the compression device is admitted into the region of the intake valves of the cylinder with a lower λ*.

5. A method according to claim 2, wherein the air/fuel ratio λ₁ of the air/fuel mixture which is compressed in the compression device is selected to be high enough (λ₁>λ_{crit}) such that it is not ignitable under the conditions in the region upstream of the fuel feed or fuel/air mixture feed with a lower λ*.

6. A method according to claim 2, wherein the fuel supplied downstream of the compression device is a different fuel from the fuel compressed in the compression device.

7. An internal combustion engine comprising at least:
a. an air intake;
b. a first fuel intake;
c. a fuel/air mixing device wherein the air intake and first fuel intake discharge into the fuel/air mixing device;
d. a compression device connected downstream of the fuel/air mixing device;
e. a second fuel intake which is connected downstream of the compression device;
f. an intake manifold;
g. a cylinder in which a combustion chamber is formed; and
h. a regulating device or control device;
wherein the regulating device or control device regulates or controls the supply of fuel to the combustion chamber as a function of the operating state of the internal combustion engine via the at least two fuel intakes, wherein the regulating device or control device adjusts the air/fuel ratio λ₁ of the air/fuel mixture which is compressed in the compression device so that it is not ignitable under the conditions in the compression device and/or upstream of the compression device.

8. An internal combustion engine according to claim 7, wherein the regulating device keeps the air/fuel ratio λ₁ supplied via the first fuel intake essentially constant and regulates the fuel supply via the second fuel intake as a function of the operating conditions of the internal combustion engine.

9. An internal combustion engine according to claim 7, wherein the second fuel intake discharges into the intake manifold.

10. An internal combustion engine according to claim 9, wherein the second fuel intake is formed as a port injector.

11. An internal combustion engine according to claim 7, wherein the second fuel intake discharges directly into the combustion chamber of the cylinder.

12. A regulating device for an internal combustion engine according to claim 7.

13. A regulating device for an internal combustion engine for carrying out a method according to claim 1.
